(19) United States
(12) Patent Application Publication
(10) Pub. No.: US 2016/0208516 A1
(43) Pub. Date: Jul. 21, 2016

(54) Apparatus for Reminding Drivers of a Child in a Vehicle

(71) Applicant: Richard E. Dearman, Huntsville, AL (US)

(72) Inventor: Richard E. Dearman, Huntsville, AL (US)

(21) Appl. No.: 14/602,144

(22) Filed: Jan. 21, 2015

(51) Int. Cl. E05B 13/00

(52) U.S. Cl. CPC E05B 13/001

(57) ABSTRACT

An apparatus for reminding drivers of a child in a vehicle configured to be hung on the interior of a driver's door so that it interferes with operation of the door handle. Thus, when the driver opens the door, the driver is reminded of a child in the vehicle.

### BRIEF DESCRIPTION OF THE DRAWINGS

The apparatus is described with reference to the accompanying drawings. In the drawings, like reference numbers indicate identical or functionally similar elements.

FIG. 1 presents the interior of an exemplary vehicle in which a first embodiment of the apparatus may be used;

FIG. 2 is a detailed view of the first embodiment of FIG. 1;

FIG. 3A shows another exemplary embodiment of the apparatus;

FIG. 3B illustrates application of the embodiment of FIG. 3A;

FIG. 4 shows another exemplary embodiment of the apparatus;

FIG. 5 shows another exemplary embodiment of the apparatus;

FIG. 6 shows another exemplary embodiment of the apparatus;

FIGS. 7A & 7B shows another exemplary embodiment of the apparatus;

FIG. 7C illustrates application of the embodiment of FIGS. 7A & 7B; and

FIG. 8 illustrates locations that the apparatus may be attached in the vehicle's rear seat area using any of the various embodiments of FIGS. 2 through 7B.

### DETAILED DESCRIPTION

The various embodiments of the apparatus and their advantages are best understood by referring to FIGS. 1 through 8 of the drawings. The elements of the drawings are not necessarily to scale, emphasis instead being placed upon clearly illustrating the novel features and principles of operation. Throughout the drawings, like numerals are used for like and corresponding parts of the various drawings.

Furthermore, reference in the specification to “an embodiment,” “one embodiment,” “various embodiments,” or any variant thereof means that a particular feature or aspect described in conjunction with the particular embodiment is included in at least one embodiment. Thus, the appearance of the phrases “in one embodiment,” “in another embodiment,” or variations thereof in various places throughout the specification are not necessarily all referring to its respective embodiment.

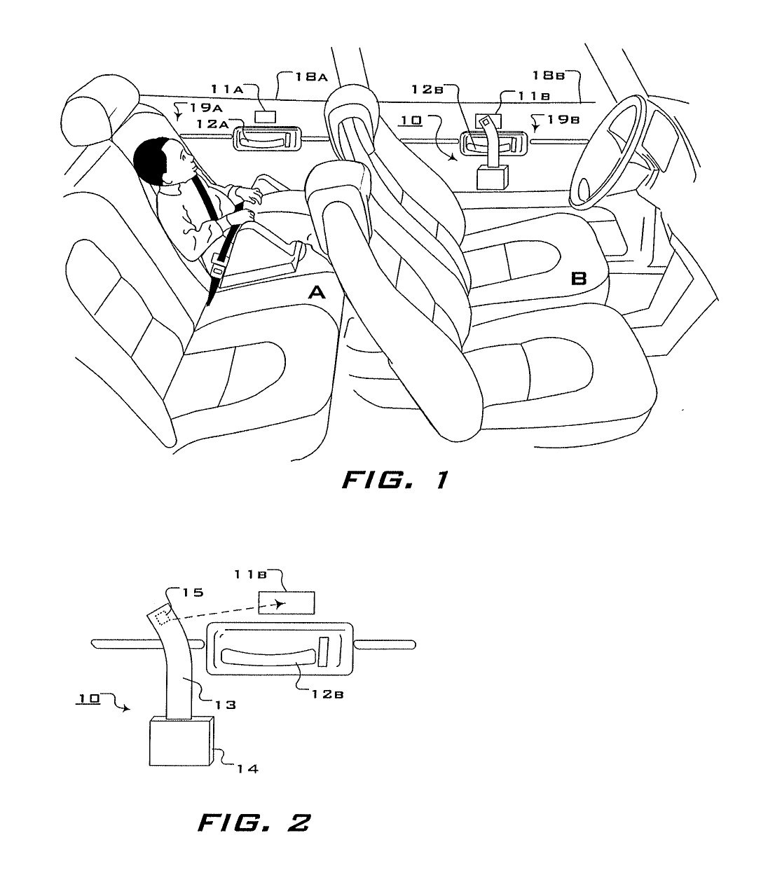

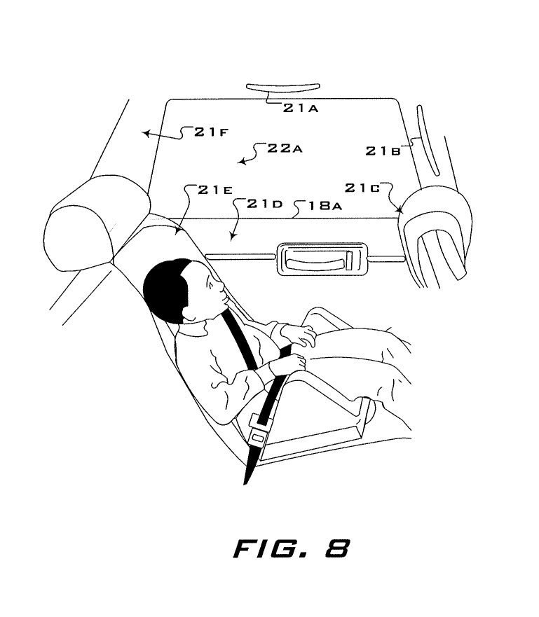

FIG. 1 depicts an interior of a vehicle having a back seat A, a front seat B, a rear door 18A, and a driver's door 18B. Doors 18A, B, are configured with door handles 12A, B, respectively, for opening the doors 18A, B from the inside. The apparatus 10 is shown in this embodiment located on the interior of the driver's door 18B, attached thereto by fastening member 11B affixed to the interior door panel, just above the door handle 12B such that when the apparatus 10 is attached it hangs over the handle 12B so the handle cannot be grasped without moving the apparatus 10 out of the way. The apparatus attachment point in the rear of the vehicle may be at location 11A in FIG. 1 or any of the various locations shown in FIG. 8. With reference to FIG. 2, an exemplary embodiment of the apparatus 10 comprises flexible strip 13 comprising a second fastening member 15 permanently attached to an end of the strip 13. At the opposite end, the strip 13 is preferably attached to a container 14. The second fastening member 15 removably adheres to the attachment member 11B affixed to the door panel. In one embodiment, fastening member 11B may be a strip of Velcro ® hook fabric while the second fastening member 15 may be a strip of the Velcro ® loop fabric. Other fasteners may be used as will be appreciated by those with the benefit of this disclosure, including snaps, or magnets, or the like. Container 14 is an optional but advantageous attachment to the strip 13, and may be any suitable closable container, preferably lightweight, and may be used to hold cards comprising information about the child, emergency numbers, or the like. Advantages of including the container 14 on the end of the strip 13 are that it acts as a weight and provides additional presence and visibility to the apparatus to ensure that it will be noticed and removed from its rear compartment location before the back door is closed once the child is placed in the car.

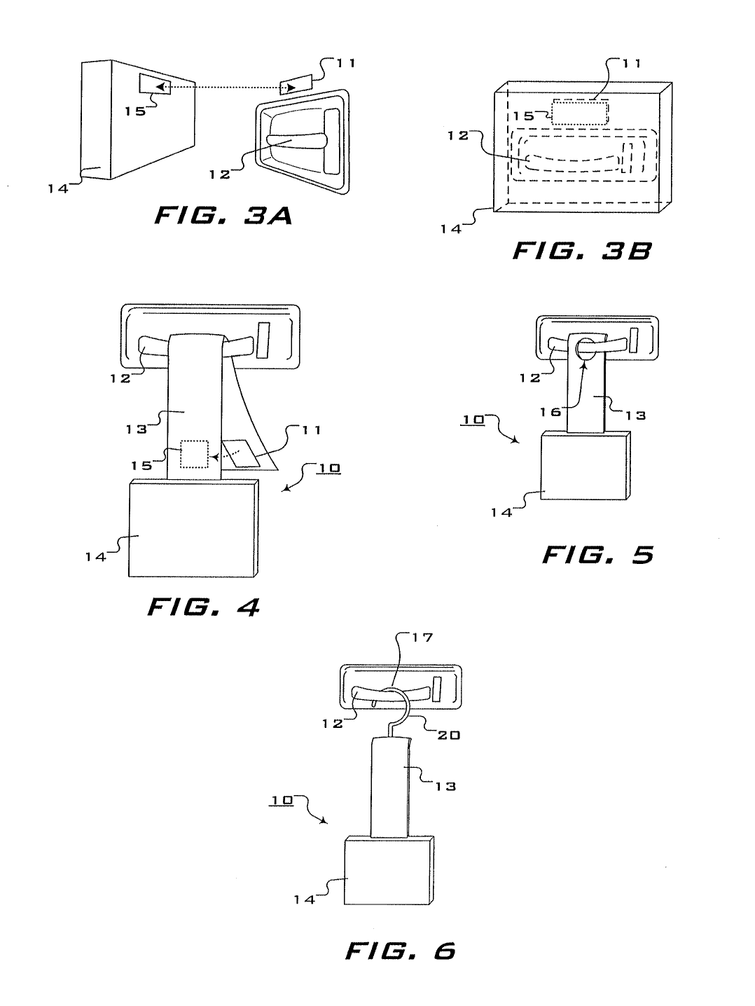

FIGS. 3A and 3B show a further embodiment in which the container 14 includes the second fastening member 15 affixed directly to one side of the container 14 and fastens the container 14 to the door panel 19 such that it is superimposed over the door handle 12. In this way, the user must remove the container 14 in order to operate the door handle 12, thus reminding the user there is a child in the vehicle.

FIGS. 4 through 6 show other exemplary embodiments of the apparatus 10. First, in FIG. 4, the apparatus 10 comprises an elongated strip 13 that may be folded over the door handle 12B, creating a loop. In this embodiment, the first attachment member 11 is affixed to the end of the strip on the interior surface thereof, while the second fastening member 15 is attached to the interior surface of the opposite end of the strip 13, near the container 14, such that the two fastening members oppose each other and may be fastened together creating the loop. Of course, the strip 13 may be formed into a permanent loop.

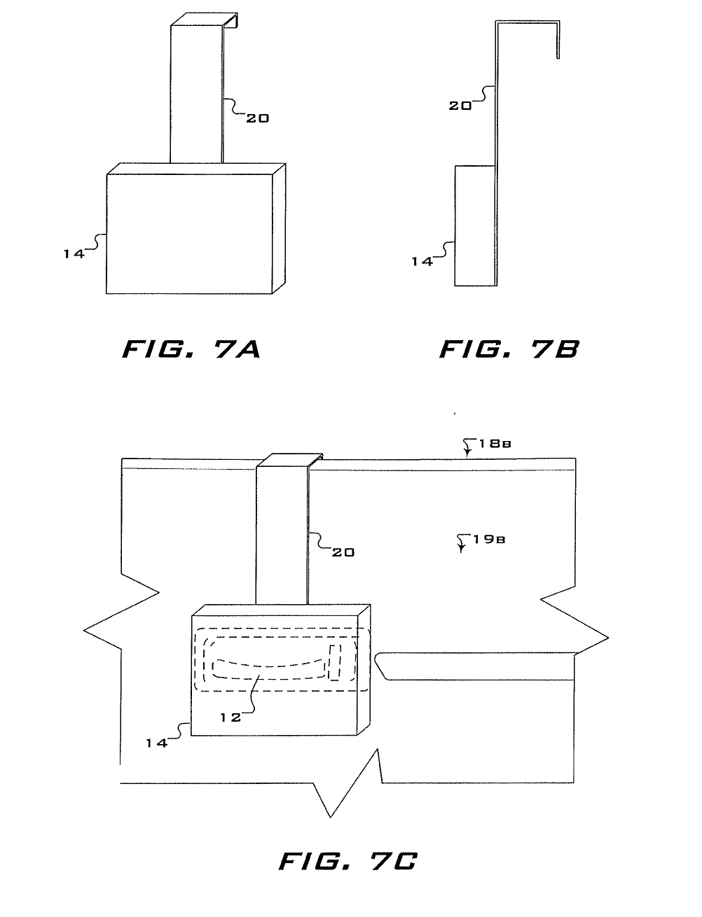

In FIG. 5, the strip may be configured with a hole 16 in the free end. FIG. 6 shows a version in which the strip 13 includes a hook 20 attached to the free end. Thus, in these versions, the apparatus hangs from the handle 12B.

A further embodiment is illustrated in FIGS. 7A through 7C where the container 14 comprises an elongated member 20 with a hooked free end 21. The hooked free end 21 may be engaged by inserting it between the window glass and the door 18B or 18A. The elongated member 20 should have a length such that when the hooked free end 21 is engaged the container 14 rests over the door handle 12. Again, the user must remove the apparatus 10 to open the door 18B. Placement of the apparatus 10 on the rear door would not need to cover the rear door handle 12A.

Thus configured, after placing a child in the rear of the vehicle, the driver attaches the apparatus to the driver's door interior door panel 19b in a manner that requires the apparatus to be removed in order to access the door handle. When the driver exits the vehicle the removed apparatus will be held by the driver, as a reminder to get the child. As the driver opens the back door 18A the apparatus is then attached in the rear of the vehicle A as shown in the drawings. The apparatus will remain in the rear A until the next time the child is placed in the vehicle and then the driver will repeat the process. Thus, the driver cannot open the driver door 18B without being reminded of the child in the back seat. When the driver opens the back door 18A to remove the child the apparatus is immediately placed in a location as depicted in FIG. 8. The device will remain in that conspicuous location until the child is next placed in the vehicle.

FIG. 8 depicts potential attachment points for any of the various embodiments of the apparatus for the rear compartment. The desirable characteristics of the chosen attachment point(s) include, easy access for the driver after the back door is opened, conspicuous visibility so that the apparatus 10 will be noticed for subsequent removal once the child is placed in the seat for transport, and minimal interference for other uses of the rear compartment so as to allow the apparatus to remain in place until the next time the child is placed in the vehicle. In FIG. 8, 21A and 21B are locations that embodiments such as shown in FIG. 4 and FIG. 6 may be used. Attachment location 21D could be used by embodiments as shown in FIG. 2 and FIG. 3 and may or may not result in the apparatus 10 covering the door handle. Attachment location 21F could be used to by embodiments like shown in FIGS. 3 and FIGS. 3A or 3B. Apparatus location 21D could be used for embodiments as shown in FIGS. 7A, 7B, and 7C, however location 21D would may or may not cover the door handle. The apparatus locations 21E and 21C could be used by the embodiments shown in FIGS. 7A and 7B when the head rests supports allow such access.

As described above and shown in the associated drawings, the present invention comprises an apparatus for reminding drivers of a child in the vehicle. While particular embodiments have been described, it will be understood, however, that any invention appertaining to the apparatus/system/method described is not limited thereto, since modifications may be made by those skilled in the art, particularly in light of the foregoing teachings. It is, therefore, contemplated by the appended claims to cover any such modifications that incorporate those features or those improvements that embody the spirit and scope of the invention.

What is claimed is:

1. An apparatus for reminding drivers of a child in a vehicle comprising:
a container configured with attachment means, said attachment means comprising one of a fastener and a hanger, to the interior of a driver's car door such that said container covers the driver's car door interior handle such that the apparatus must be removed in order to operate the handle.

2. The apparatus of claim 1, wherein said fastener is one of Velcro, snaps, and magnets.

3. The apparatus of claim 1, wherein said hanger comprises an elongated member attached at one end to said container and a free end configured with a hook.

4. The apparatus of claim 3, wherein said elongated member is a stiff elongated member.

5. The apparatus of claim 3, wherein said elongated member is a flexible elongated member.

6. The apparatus of claim 1, wherein said hanger comprises an elongated member attached at one end to said container and a free end in which a hole is defined.
